(19) United States
(12) Patent Application Publication
(10) Pub. No.: US 2021/0146589 A1
(43) Pub. Date: May 20, 2021

(54) EXTRUSION DIE FOR PRODUCING A PLASTIC PROFILE

(71) Applicant: Extrunet GmbH, Eberstalzell (AT)

(72) Inventors: Dietmar Gruber, Schlierbach (AT); Thomas Stadlhuber, Gmunden (AT)

(21) Appl. No.: 16/951,761

(22) Filed: Nov. 18, 2020

(30) Foreign Application Priority Data
Nov. 20, 2019 (AT) A 60263/2019

(51) Int. Cl. B29C 48/32; B29C 48/12; B29C 48/09; B29C 48/90

(52) U.S. Cl. CPC B29C 48/32; B29C 48/12; B29L 2031/005; B29C 48/904; B29C 48/09

(57) ABSTRACT

Aspects of the present disclosure are directed to an extrusion die for producing a plastic profile. In some embodiments, the extrusion die includes a first die plate having a flow channel for the plastic profile to be produced, at least one recess configured and arranged for accommodating exchangeable air nozzle inserts, and a connection on the outside of the first die plate. The exchangeable air nozzle inserts have an air channel with at least one air outlet nozzle. The extrusion die further including at least one air supply bore that leads from the connection on the outside of the first die plate into each of the at least one recess.

The present invention relates to an extrusion die for producing a plastic profile with a first die plate having a flow channel for the plastic profile to be produced.

When extruding window profiles, the starting material (dryblend) is prepared in an extruder so that a homogeneous melt is produced, which is pressed through an extrusion die at a pressure of approx. 300 bar. In the extrusion die, the melt approximately assumes the contours of the profile. At a short, distance after the die, the profile strand enters the dry calibration and then passes through a wet calibration. Depending on the profile wall thickness, the lengths of the dry and wet calibration are approx. 0.5 m and 6 m at low pull-off speeds and up to 1 m and 18 m at high pull-off speeds. The calibration has the task of supporting the profile during the cooling process. The exact, geometry of the shaping surfaces of the calibration depends on the shrinkage behavior of the plastic and the extrusion speed and is decisive for dimensionally accurate profiles within the tolerances. After the wet calibration, the now largely cooled profile is captured by the caterpillar pull-off, which transports the profile at a constant speed through the calibration section to the saw or cutter. In the sawing unit, the endless extruded profile is cut to profile bars of usually 6 m length, which are then deposited in a deposit table and from there transferred to a container.

It is known that the impact of air on the profile surface immediately after leaving the extrusion die has a significant effect on the surface quality of the profile as well as on the feeding behavior in the first dry calibration. The distance between the end faces of the extrusion die and the first dry calibration is usually about 6 to 10 mm. After leaving the extrusion die, the hot melt swells slightly, i.e. the wall thicknesses increase before they are reduced again according to the pull-off speed. This is a critical process, especially in the case of single-walled, protruding profile sections, so-called extremities, because they have contact with the calibration on both sides. Usually, the gap at the beginning of the dry calibration is about 0.2 mm larger than the wall thickness of the finished profile. The melt in the transition zone in these profile sections can be thicker for a short time than in the cooled profile, so that there is a risk of getting stuck. This transition zone starts at the end face of the die and extends up to 50 mm into the calibration. Blowing with cold or hot air reduces both the friction of the melt against the calibrator wall (with cold blowing air), the tensile strength of the profile segment by cooling the edge layer (with cold blowing air) and the swelling of the melt in the transition zone (with hot blowing air). The hot blowing air causes the particularly high internal stresses of the melt in the edge layer to relax more quickly and therefore the swelling is reduced. Experiments should be carried out to determine which effect predominates, so that the feed behavior into the first dry calibration can be optimized.

EP 1 023 983 A shows how the profile surface is exposed to air after leaving the extrusion die. It is shown that the air flow is directed towards single-wall profile sections protruding from the profile. A disadvantage of this arrangement is that the bore for the air outlet nozzle is incorporated directly into the die plate and therefore cannot be changed with little effort and flexibly with regard to flow velocity, angle of impact and exact position of impact in the course of matching the nozzle and calibration.

AT 519 313 A discloses a similar arrangement for applying air to the profile surface, with a die plate in the air outlet area.

The known devices can basically be set up in such a way that the profile is selectively exposed to air for cooling or heating in order to reduce the problems described above. However, it is difficult to reproducibly restore the same conditions in case of modifications to the extrusion die or extrusion line, since the profile is sensitive to changes in location, direction and intensity of air flows. Furthermore, the temperature of the air is critical. Even a quick adaptation to different profile geometries is not possible in a satisfactory way.

With both cited patent specifications, it is difficult and laborious to realign the air flow when adjusting the extrusion die in order to optimize the profile quality and to define these improved conditions in an exactly reproducible manner. In the first case, the extrusion line must be shut down and the extrusion die must be completely disassembled. Only then can existing air outlet nozzles be closed and new nozzles drilled, often new supply bores must also be made. In the second case, if the nozzle body is magnetically fixed to the face of the extrusion die, the nozzle body could be moved, but the angle of impact could not be changed. In addition, the exact position of the nozzle body cannot be determined in a reliably reproducible manner. Unintentional displacements of the nozzle body because someone tugged at its air supply line could lead to rejects or to an interruption of production. In addition, any components protruding from the end face of the die will interfere with the normal operating sequence when adjusting the extrusion die and during the ongoing extrusion.

It is the object of the present invention to further develop an extrusion die of the above type so that the extruded profile can be flexibly and reproducibly exposed to air in order to optimize the profile quality. In particular, individual areas of the profile strand should be able to be selectively exposed to air flow.

It is provided according to the invention that at least one recess is provided in the first die plate for receiving exchangeable air nozzle inserts, which have an air channel with at least one air outlet nozzle, wherein at least one air supply bore leads from a connection on the outside of the first die plate into each recess.

The solution according to the invention offers the advantage that it is possible to design an extrusion die in a modular way, wherein a standardized recess can accommodate different air nozzle inserts that are adapted to the circumstances. If necessary, the air nozzle insert can be easily and cost-effectively reworked or replaced by an alternative air nozzle insert. This also ensures that an optimized setting can always be reproduced exactly if the extrusion die or extrusion line has to be modified in the meantime.

It is particularly advantageous if the air outlet nozzle is directed at an area of the profile to be produced. This area can be cooled or heated as required.

A special flexibility in the technical implementation can be achieved in that the air channel has several supply openings for connection with an air supply bore. An extrusion die is a complex component with bores for dowel pins, screws and the like. It is therefore not always possible to install an air supply bore in a certain area. An air nozzle insert has several feed openings, so that it can be used in different extrusion dies that require different positions for the air supply bore.

A particularly advantageous embodiment variant of the invention provides for the air supply to flow into a distribution chamber. From this distribution chamber one or more air outlet nozzles originate, each of which can be individually designed with regard to exact position, diameter and angular position.

In another embodiment, the air nozzle insert has a depression or groove on the outside that is connected to the air channel. This makes it possible to guide the air also in this depression on the outside of the air nozzle insert in the recess, which further improves the variability in difficult space conditions.

The present invention also relates to an extrusion process of plastic profiles using an extrusion die with a flow channel for forming a profile with a first die plate in which recesses are provided for accommodating air nozzle inserts which have air outlet nozzles for the blowing air, wherein the blowing air is directed at an angle between 0° and 45° onto the profile strand exiting the extrusion die.

In the following, the invention is explained in more detail by means of exemplary embodiments, wherein:

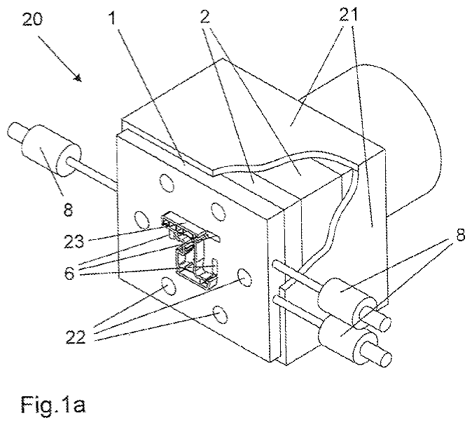

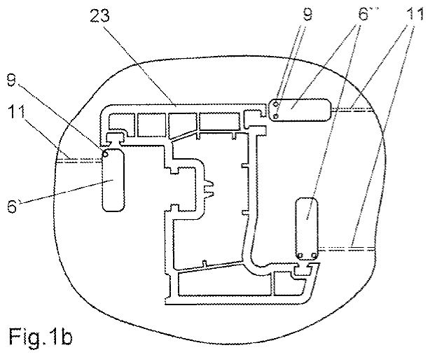

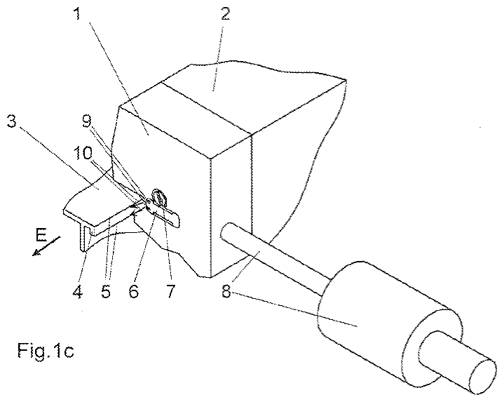

FIG. 1a shows an extrusion die according to the invention with 3 air nozzle inserts in an oblique view;

FIG. 1b shows a section of the extrusion die of FIG. 1a in a frontal view;

FIG. 1c shows a section of the extrusion die from FIG. 1a, but with simplified contours, in an oblique view;

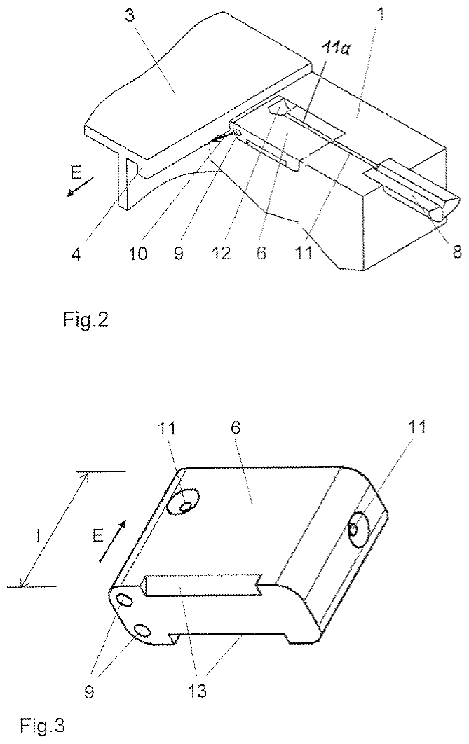

FIG. 2 shows a detail from FIG. 1c in sectional view in the center plane of the air nozzle insert in oblique view;

FIG. 3 shows a first air nozzle insert according to the invention and according to FIG. 1c in oblique view;

FIG. 4 shows a sectional view of the air nozzle insert according to FIG. 3 in oblique view;

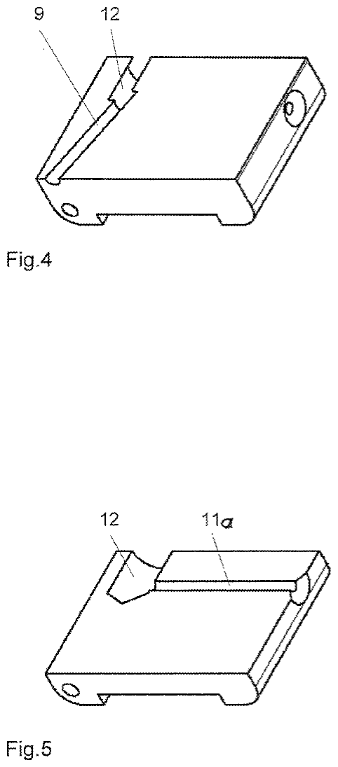

FIG. 5 shows a further sectional view of the air nozzle insert according to FIG. 3 in oblique view;

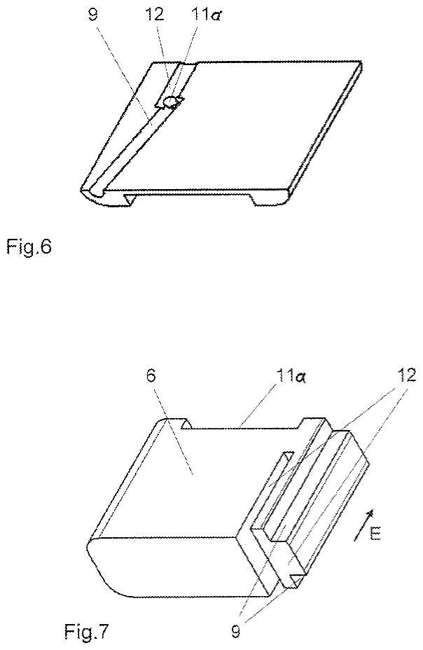

FIG. 6 shows a further sectional view of the air nozzle insert according to FIG. 3 in oblique view;

FIG. 7 shows a second air nozzle insert according to the invention in oblique view.

FIG. 1a generally shows an extrusion die 20 having a first die plate 1 and a die body consisting of several additional die plates 2. This extrusion die 20 is heated by heating plates 21. It is designed for the extrusion of a wing profile 23. The wing profile 23 has three profile extremities for which three air nozzle inserts 6 are embedded in the front face of the first die plate 1. Each air nozzle insert 6 is supplied with blowing air via heating probes 8. The supply bores 11 for the blowing air located in the first die plate 1 must not collide with the screw connection 22 or other built-in components.

FIG. 1b shows a section of the extrusion die 20 from FIG. 1a in a frontal view. The supply bores 11 open into the air nozzle inserts 6, 6′, 6″ at different positions. The air nozzle insert 6′ has only one air outlet nozzle 9, the air nozzle inserts 6″ each have two air outlet nozzles 9. Each air outlet nozzle 9 directs the air to a specific point of the profile strand 3 of the wing profile 23 exiting the extrusion die 20. By exchanging or reworking the air nozzle inserts 6, the air jet can be directed to desired points of the profile strand 3 with little effort.

FIG. 1c shows in detail the upper right-hand corner area of extrusion die 20 in an oblique view against extrusion direction E, wherein the geometry of the profile strand 3 is slightly modified compared to the wing profile 23 and the geometry of the first die plate 1. The first die plate 1 seals the extrusion die 20 in the direction of extrusion. From this first die plate 1, the profile strand 3 emerges as a melt with a dough-like consistency in extrusion direction E. Only a part of profile strand 3 is shown. The single-walled profile segment 4 protrudes from profile strand 3 and is formed in a hook-shaped manner in this case. The air nozzle insert 6 is embedded flush in the front face of the die plate 1 and can be fixed with the countersunk screw 7. The air nozzle insert 6 is supplied with room air or heated air via the heating probe 8. The two air outlet nozzles 9, which are designed as holes in the air nozzle insert 6, are used to blow one air jet each at the edges 5 of the single-walled profile segment 4, which is symbolized by two arrows 10.

The intensity of the air jet as well as its temperature can be varied within wide limits by means of a control device, which will not be discussed in detail. The flow velocity of the air jet 10 can be varied by pressurizing the heating probe 8 with compressed air at different pressures in the range of 0 to 4 bar. The cross-sections and lengths of the actual air outlet nozzle 9 as well as in the supply line in the air nozzle insert 6 and in the die plate 1 limit the air flow rate to reasonable values, max. approx. 0.4 Nm³/min. The diameters in the supply line are deliberately kept “small”, approximately from 0.8 to 2 mm. The temperature of the blowing air can be adjusted within a range from room temperature to 600° C. If necessary, the blowing air can also be cooled, for which purpose the cold air is sucked in with a compressor from an air heat exchanger, which can be cooled down to −40° C.

In FIG. 2, a detail from FIG. 1c is shown in sectional view. The blowing air is introduced from the heating probe into the first die plate 1 and is led via supply bores 11 to the distribution chamber 12, which is located in the air nozzle insert 6. The supply bores have a small diameter in order to limit the throughput of the blowing air and to keep the temperature exchange between blowing air and die plate low. The single-wall profile segment 4 is impinged in a small area by an air jet 10, which exits from the air outlet nozzle 9. This air outlet nozzle 9 is supplied with the blowing air from the distribution chamber 12. The cross-section of the air outlet nozzle 9 as well as its angular position to the extrusion direction E can be varied within wide limits: Bore diameters between 0.8 and 3 mm as well as angles between 0 and 45°, preferably between 10 and 25°, have proven to be very effective.

FIG. 3 shows a first, non-exclusive embodiment of the air nozzle insert 6 (view diagonally against the extrusion direction E) according to the invention. The air nozzle insert 6 has three supply bores 11 as standard: one on the right side and one each on the upper and lower side of the air nozzle insert (relative to the position of the air nozzle insert in this Fig.). Countersinking of the supply bores is advisable so that the supply bore in the nozzle can have large tolerances with respect to the point of impact. Two mounting chamfers 13 are used to fix the air nozzle insert with a countersunk screw 7. These mounting chamfers 13 allow many different positions for the countersunk screw 7 so that collisions with other design elements can be safely avoided. Not shown is a “trigger thread” which is countersunk in the front side of the air nozzle insert 6, between the two mounting chamfers. The dimension I for the depth of the air nozzle insert 6 is freely selectable within wide limits, but is limited at the top by the thickness of the first die plate 1, minus approx. 2 mm. Depths between 15 and 18 mm have proven to be effective. Up to this point the description corresponds to a basic form of the air nozzle insert, which can be uniformly designed for almost all applications. Only the two holes that form the air outlet nozzles 9 go beyond the basic form.

FIG. 4 shows a sectional view of the air nozzle insert 6 according to FIG. 3. The sectional plane is at the height of the bore for the upper air outlet nozzle 9. The outlet nozzle is supplied with blowing air from the inlet side of the distribution chamber 12. The bore has an angle of approx. 15° to the extrusion axis, so that the profile segment 3 is subjected to an oblique flow.

FIG. 5 shows another sectional view of the air nozzle insert 6 according to FIG. 3. The sectional plane is at the level of the supply bore 11 for the blowing air. The distribution chamber 12, which in this case is a blind hole, is supplied with blowing air via this bore.

FIG. 6 shows another sectional view of the air nozzle insert 6 according to FIG. 3. The sectional plane is at the level of the bore for the lower air outlet nozzle 9. The description corresponds to that of FIG. 4. In addition, the lower air supply bore 11 for the blowing air can be seen.

FIG. 7 shows another embodiment of an air nozzle insert 6 in an oblique view (in extrusion direction E). The distribution chamber 12 for the blowing air is designed as a slot. Upstream, in relation to the direction of extrusion, this slot is continued around the edge, in installation position towards profile segment 4, in FIG. 7 thus to the right, by a flattening. The two supply bores 11, which are provided in the first embodiment according to FIG. 2 on the upper and lower side, can be omitted here because the supply bore 11 of the nozzle opens into the slot which forms the distribution chamber 12. This basic shape has the advantage that the air outlet nozzles 9 can be manufactured both as an inclined bore and as a channel-shaped channel on the outer circumference of the air nozzle insert 6, which is bounded by the wall of the receiving groove when installed. Such channels can be easily made and reworked by means of a handsaw or file without the aid of a machine. The disadvantage that the air jet 10 is now directed parallel to the extrusion direction is hardly noticeable, since the outlet nozzle is positioned closer to the profile segment 4.

1. Extrusion die for producing a plastic profile comprising:
a first die plate including
a flow channel for the plastic profile to be produced,
at least one recess configured and arranged for accommodating exchangeable air nozzle inserts, and
a connection on the outside of the first die plate;
wherein the exchangeable air nozzle inserts have an air channel with at least one air outlet nozzle; and
at least one air supply bore that leads from the connection on the outside of the first die plate into each of the at least one recess.

2. The extrusion die according to claim 1, characterized in that the at least one air outlet nozzle is directed towards a region of the plastic profile to be produced.

3. The extrusion die according to claim 1, characterized in that the air channel of the exchangeable air nozzle inserts has a plurality of supply openings connected to the at least one air supply bore.

4. The extrusion die according to claim 1, characterized in that the air channel is connected to a distribution chamber.

5. The extrusion die according to claim 1, characterized in that the exchangeable air nozzle inserts have a depression communicating with the air channel and forming the at least one air outlet nozzle.

6. The extrusion die according to claim 1, characterized in that each of the exchangeable air nozzle inserts are positioned in the at least one recess.

7. Extrusion method of plastic profiles with an extrusion die with a flow channel for forming a profile, the method including the following steps:
providing a first die plate including recesses for receiving air nozzle inserts, the air nozzle inserts including air outlet nozzles;
blowing air through the air outlet nozzles;
directing the blown air at an angle between 0° and 45° onto the profile strand emerging from the extrusion die.

8. The extrusion method of claim 7, wherein the step of blowing air further includes utilizing an air supply bore for blowing the air from an outside of the first die plate to each recess.

9. The extrusion method of claim 7, characterized in that the blowing air is at room temperature.

10. The extrusion method of claim 7, characterized in that the blowing air is preheated to a temperature between 200° C. and 600° C.
